(19) United States
(12) Patent Application Publication
(10) Pub. No.: US 2026/0075001 A1
(43) Pub. Date: Mar. 12, 2026

(54) CONGESTION LEVEL MEASUREMENT DEVICE, CONGESTION LEVEL MEASUREMENT SYSTEM, CONGESTION LEVEL MEASUREMENT METHOD, AND STORAGE MEDIUM STORING CONGESTION LEVEL MEASUREMENT PROGRAM

(71) Applicants: Mitsubishi Electric Corporation, Tokyo (JP); The University of Tokyo, Tokyo (JP)

(72) Inventors: Shogo SHIMIZU, Tokyo (JP); Ryoji HATTORI, Tokyo (JP); Takayuki KODAIRA, Tokyo (JP); Sakurako TANIDA, Tokyo (JP); Claudio FELICIANI, Tokyo (JP); Katsuhiro NISHINARI, Tokyo (JP)

(73) Assignees: Mitsubishi Electric Corporation, Tokyo (JP); The University of Tokyo, Tokyo (JP)

(21) Appl. No.: 19/390,928

(22) Filed: Nov. 17, 2025

Related U.S. Application Data
(63) Continuation of application No. PCT/JP2023/022621, filed on Jun. 19, 2023.

(51) Int. Cl. H04L 47/127; H04L 47/11

(52) U.S. Cl. CPC H04L 47/127; H04L 47/115

(57) ABSTRACT

A congestion level measurement device includes a data reception unit to receive wireless data based on wireless signals received by one or more wireless sensors in a place having been set in order to accommodate guests, a guest count calculation unit to calculate a mobile wireless terminal count, as the number of mobile wireless terminals carried by the guests in the place and transmitting the wireless signals, based on the wireless data or based on the wireless data and permanent wireless terminal information acquired as information regarding permanent wireless terminals transmitting the wireless signals, and to calculate a guest count as the number of the guests from the mobile wireless terminal count, and a congestion level calculation unit to calculate a congestion level, indicating a degree of congestion with the guests in the place, based on the guest count.

### CROSS-REFERENCE TO RELATED APPLICATION

This application is a continuation application of International Application No. PCT/JP2023/022621 having an international filing date of Jun. 19, 2023, which is hereby expressly incorporated by reference into the present application.

### BACKGROUND OF THE INVENTION

### 1. Field of the Invention

The present disclosure relates to a congestion level measurement device, a congestion level measurement system, a congestion level measurement method and a congestion level measurement program.

### 2. Background Art

In a venue of an event as a place where a lot of people gather, the risk of collision between guests and the risk of infection among guests are expected to increase with congestion. In order for each guest to select an appropriate action based on the understanding of these risks, it is important that the guest oneself correctly grasps congestion condition in the venue. However, it is difficult for the guest to grasp the congestion condition in the large venue by relying on the guest's own sensation, and there is a danger of coming close to a risk source despite the guest's intentions. Therefore, measurement of the congestion level and presentation of the congestion condition by the organizer of the venue are being requested.

For example, Patent Reference 1 proposes a device that calculates the congestion level in a vehicle as a means of transportation being a place where a lot of people gather and thereby presents congestion information.

Further, to measure the congestion level, a method making use of a wireless sensor achieving an appropriate balance between the measurement accuracy and the operational cost is often used. Especially, a method making use of an advertisement signal as a wireless signal periodically transmitted by a mobile wireless terminal such as a smartphone carried by a person does not need distribution of a device or provision of application software and does not require cooperation of the guest, and thus is excellent in easiness of introduction. Here, the advertisement signal is a signal used for the connection between wireless terminals and including an identification number for identifying the device. For example, Non-patent Reference 1 describes an example of the use of a BLE (Bluetooth Low Energy) beacon as the advertisement signal.
Patent Reference 1: Japanese Patent Application Publication No. 2022-30906.
Non-patent Reference 1: Daisuke Sato and five others, “Visualization Service for Congestion Degree Using BLE Beacons”, IPSJ Transactions. CDS, Vol. 8, No. 1, pp. 1-10, January 2018.

However, in the measurement of the congestion level by using wireless signals transmitted from mobile wireless terminals carried by people, there is a problem in that the congestion level cannot be measured accurately in a place where a wireless terminal other than the mobile wireless terminals has been installed.

### SUMMARY OF THE INVENTION

An object of the present disclosure is to provide a congestion level measurement device, a congestion level measurement system, a congestion level measurement method and a congestion level measurement program that make it possible to measure the congestion level with high accuracy.

A congestion level measurement device in the present disclosure includes

A congestion level measurement device comprising:
processing circuitry to receive wireless data based on wireless signals received by one or more wireless sensors in a place having been set in order to accommodate guests; to calculate a mobile wireless terminal count, as a number of mobile wireless terminals carried by the guests in the place and transmitting the wireless signals, based on the wireless data or based on the wireless data and permanent wireless terminal information acquired as information regarding permanent wireless terminals transmitting the wireless signals, and to calculate a guest count as the number of the guests from the mobile wireless terminal count; to calculate a congestion level, indicating a degree of congestion with the guests in the place, based on the guest count; to obtain a permanent wireless terminal count as the number of the permanent wireless terminals based on the wireless data received in a period in which no guests are accommodated in the place; to obtain a wireless terminal count, as a sum total of the permanent wireless terminal count and the mobile wireless terminal count, based on the wireless data received in a period in which the guests are accommodated in the place; and to calculate the mobile wireless terminal count by subtracting the permanent wireless terminal count from the wireless terminal count.

A congestion level measurement method in the present disclosure includes receiving wireless data based on wireless signals received by one or more wireless sensors in a place having been set in order to accommodate guests; calculating a mobile wireless terminal count, as a number of mobile wireless terminals carried by the guests in the place and transmitting the wireless signals, based on the wireless data or based on the wireless data and permanent wireless terminal information acquired as information regarding permanent wireless terminals transmitting the wireless signals, and calculating a guest count as the number of the guests from the mobile wireless terminal count; calculating a congestion level, indicating a degree of congestion with the guests in the place, based on the guest count; calculating a congestion level, indicating a degree of congestion with the guests in the place, based on the guest count; obtaining a permanent wireless terminal count as the number of the permanent wireless terminals based on the wireless data received in a period in which no guests are accommodated in the place; obtaining a wireless terminal count, as a sum total of the permanent wireless terminal count and the mobile wireless terminal count, based on the wireless data received in a period in which the guests are accommodated in the place; and calculating the mobile wireless terminal count by subtracting the permanent wireless terminal count from the wireless terminal count.

By using the congestion level measurement device, the congestion level measurement system, the congestion level measurement method and the congestion level measurement program in the present disclosure, the congestion level of people can be measured with high accuracy.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram schematically showing the configuration of a congestion level measurement device according to a first embodiment and a congestion level measurement system including the congestion level measurement device;

FIG. 2 is a diagram showing an example of the hardware configuration of the congestion level measurement device according to the first embodiment;

FIG. 3 is a flowchart showing the operation of the congestion level measurement device according to the first embodiment;

FIG. 4 is a diagram schematically showing the configuration of a congestion level measurement device according to a second embodiment and a congestion level measurement system including the congestion level measurement device;

FIG. 5 is a flowchart showing the operation of the congestion level measurement device according to the second embodiment;

FIG. 6 is a diagram schematically showing the configuration of a congestion level measurement device according to a third embodiment and a congestion level measurement system including the congestion level measurement device;

FIG. 7 is a flowchart showing the operation of the congestion level measurement device according to the third embodiment;

FIG. 8 is a diagram schematically showing the configuration of a congestion level measurement device according to a fourth embodiment and a congestion level measurement system including the congestion level measurement device;

FIG. 9 is a functional block diagram showing the configuration of a congestion level calculation unit in FIG. 8;

FIG. 10 is a diagram showing a receivable region of a considered wireless sensor;

FIG. 11 is a diagram showing a partitioning region obtained by partitioning by a considered wireless sensor, adjacent wireless sensors and nonadjacent wireless sensors;

FIG. 12 is a diagram showing an example of the output from an overlapping wireless terminal detection unit of the congestion level measurement device in tabular form;

FIG. 13 is a diagram showing a counting region in a reference congestion level calculation process;

FIG. 14 is a diagram showing an example of a congestion level gradient vector indicating a bias of the congestion level;

FIG. 15 is a diagram showing an example of a process for calculating the congestion level gradient vector;

FIG. 16 is a diagram showing a display example of the congestion level; and

FIG. 17 is a diagram showing display examples of the congestion level before a feathering process and after the feathering process.

### DETAILED DESCRIPTION OF THE INVENTION

A congestion level measurement device, a congestion level measurement system, a congestion level measurement method and a congestion level measurement program according to each embodiment will be described below with reference to the drawings. The following embodiments are just examples and it is possible to appropriately modify each embodiment.

### First Embodiment

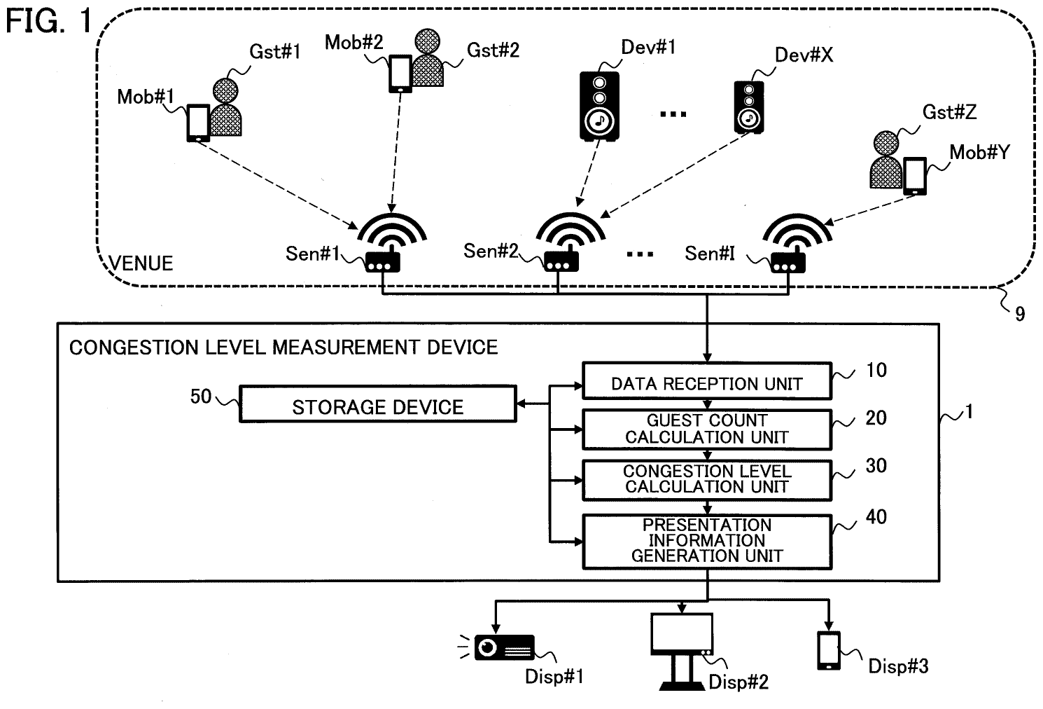

FIG. 1 is a diagram schematically showing the configuration of a congestion level measurement device 1 according to a first embodiment and a congestion level measurement system including the congestion level measurement device 1. The congestion level measurement system is formed with the congestion level measurement device 1 and one or more wireless sensors Sen #1-Sen #I. The congestion level measurement device 1 is a device for measuring the congestion level of guests (i.e., attendees or the like, hereinafter referred to as guests) in a previously set place. Further, the congestion level measurement device 1 generates presentation information for presenting congestion level information regarding the measured congestion level. The congestion level measurement device 1 is a device capable of executing a congestion level measurement method according to the first embodiment. The congestion level measurement device 1 is a computer, for example. The congestion level measurement device 1 can also be a computer system formed by cloud computing by using a computer network.

As shown in FIG. 1, the congestion level measurement device 1 includes a data reception unit 10, a guest count calculation unit 20 and a congestion level calculation unit 30. Further, the congestion level measurement device 1 includes a presentation information generation unit 40 and a storage device 50.

The data reception unit 10 receives wireless data based on wireless signals (i.e., radio waves) received by one or more wireless sensors Sen #1-Sen #I (I: positive integer) in a venue 9 as a place that has been set in order to accommodate guests Gst #1-Gst #Z (Z: positive integer). Devices transmitting the wireless signals are wireless terminals. The wireless terminals include permanent wireless terminals Dev #1-Dev #X (X: positive integer) as devices arranged in the venue 9 (i.e., devices not carried by a guest) and mobile wireless terminals Mov #1-Mov #Y (Y: positive integer) as mobile devices carried by the guests Gst #1-Gst #Z (Z: positive integer). Each permanent wireless terminal Dev #1-Dev #X is a device (e.g., audio equipment, video equipment or the like) capable of wireless communication, for example. Each mobile wireless terminal Mov #1-Mov #Y is a device carried by a person, such as a smartphone, a personal computer, a tablet terminal or a wearable device (e.g., a smartwatch of the wrist watch type, smart glasses) of the eyeglass type, or the like).

The wireless signal is transmitted from a wireless terminal repeatedly and regularly (e.g., periodically). The wireless signal is an advertisement signal, for example. The wireless signal is a signal including an identification number for identifying the device itself transmitting the wireless signal. The advertisement signal is a BLE (Bluetooth Low Energy) beacon, for example.

Each guest Gst #1-Gst #Z is represented also as a guest Gst #z, where z is an integer greater than or equal to 1 and less than or equal to Z. Each wireless sensor Sen #1-Sen #I is represented also as a wireless sensor Sen #i, where i is an integer greater than or equal to 1 and less than or equal to I. Each permanent wireless terminal Dev #1-Dev #X is represented also as a permanent wireless terminal Dev #x, where x is an integer greater than or equal to 1 and less than or equal to X. Each mobile wireless terminal Mov #1-Mov #Y is represented also as a mobile wireless terminal Mov #y, where y is an integer greater than or equal to 1 and less than or equal to Y.

The guest count calculation unit 20 calculates a mobile wireless terminal count, as the number of mobile wireless terminals Mov #1-Mov #Y carried by the guests Gst #1-Gst #Z in the venue 9 and transmitting the wireless signals, based on the wireless data received by the data reception unit 10, and calculates a guest count as the number of guests Gst #1-Gst #Z from the mobile wireless terminal count. When each of the guests Gst #1-Gst #Z can be considered to be carrying one mobile wireless terminal, the mobile wireless terminal count equals the guest count. Further, supposing that an assumed value of the number of mobile wireless terminals (transmitting the advertisement signals) carried by each of the guests Gst #1-Gst #Z is A [terminals/person], the guest count can be calculated from the mobile wireless terminal count and the assumed value A.

Specifically, the guest count calculation unit 20 obtains a permanent wireless terminal count as the number of permanent wireless terminals Dev #1-Dev #X based on the wireless data received in a period in which no guests are accommodated in the venue 9 (e.g., before the opening time), and obtains a wireless terminal count, as the sum total of the permanent wireless terminal count and the mobile wireless terminal count, based on the wireless data received in a period in which the guests Gst #1-Gst #Z are accommodated in the venue 9 (e.g., after the opening time). The guest count calculation unit 20 calculates the mobile wireless terminal count by subtracting the permanent wireless terminal count from the wireless terminal count, and further calculates the guest count.

The congestion level calculation unit 30 calculates the congestion level, indicating the degree of congestion with the guests Gst #1-Gst #Z in the venue 9, based on the guest count calculated by the guest count calculation unit 20. While the congestion level can be represented by the number of guests Gst #1-Gst #Z in the entire venue 9, the congestion level may also be represented by the number of guests per unit area. The congestion level calculation unit 30 can calculate the number of guests per unit area by dividing the guest count by the area of the venue. When the venue 9 is divided into a plurality of regions (namely, regions whose areas are already known) and the position of each guest Gst #1-Gst #Z in the venue 9 (i.e., in which region each guest is situated) can be detected, the congestion level can be calculated for each region obtained by the division. Such an example will be described later in a fourth embodiment.

The presentation information generation unit 40 generates the presentation information for presenting the congestion level calculated by the congestion level calculation unit 30 to the guests Gst #1-Gst #Z. The presentation information may include a map of the venue 9. The presentation information is video information, audio information or the like, for example. The presentation information is presented to the guests Gst #1-Gst #Z by information provision devices Disp #1-Disp #3. Each information provision device Disp #1-Disp #3 is, for example, a display device installed in the venue 9, an audio provision device that provides audio information to the venue, a personal computer or a smartphone carried by a guest Gst #1-Gst #Z, or the like.

In the first embodiment, the congestion level measurement system includes one or more information provision devices Disp #1-Disp #3 in addition to the congestion level measurement device 1 and the one or more wireless sensors Sen #1-Sen #I.

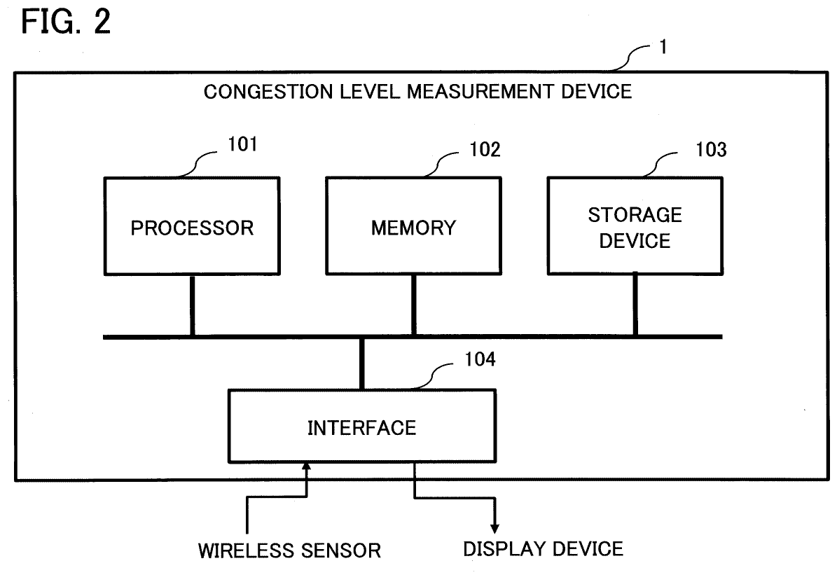

FIG. 2 is a diagram showing an example of the hardware configuration of the congestion level measurement device 1 according to the first embodiment. The congestion level measurement device 1 includes a processor 101 such as a CPU (Central Processing Unit), a memory 102 as a storage device such as a RAM (Random Access Memory), a storage device 103 that is a nonvolatile storage device such as an HDD (Hard Disk Drive) or an SSD (Solid State Drive), and an interface 104. These components may also be formed with dedicated processing circuitry.

The processor 101 is capable of executing a congestion level measurement program according to the first embodiment. The congestion level measurement program is provided via a record medium (i.e., storage medium) such as an SD memory card (Secure Digital memory card), a USB (Universal Serial Bus) memory card or the like storing the program, or by the downloading via a network, for example. The storage medium may be a non-transitory computer-readable storage medium storing a program such as the authoring program. The hardware configuration shown in FIG. 2 is just an example and a variety of modifications in the hardware configuration are possible.

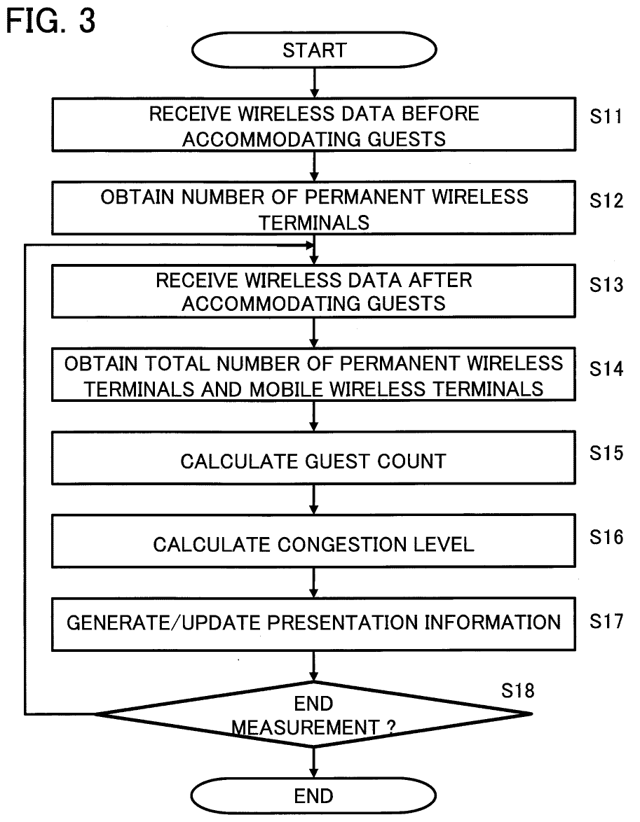

FIG. 3 is a flowchart showing the operation of the congestion level measurement device 1 according to the first embodiment. In the first embodiment, the guest count calculation unit 20 first obtains the permanent wireless terminal count as the number of permanent wireless terminals Dev #1-Dev #X based on the wireless data received in a period in which no guests are accommodated in the venue 9 (steps S11 and S12).

Subsequently, the guest count calculation unit 20 obtains the wireless terminal count, as the sum total of the permanent wireless terminal count and the mobile wireless terminal count, based on the wireless data received in a period in which the guests Gst #1-Gst #Z are accommodated in the venue 9 (steps S13 and S14).

Subsequently, the guest count calculation unit 20 calculates the mobile wireless terminal count by subtracting the permanent wireless terminal count from the wireless terminal count. In the first embodiment, the guest count calculation unit 20 calculates the guest count from the mobile wireless terminal count (step S15). In the calculation of the guest count, a value other than 1 may be used as the assumed value A.

Subsequently, the congestion level calculation unit 30 calculates the congestion level in the venue 9 (or the congestion level of each region in the venue 9) (step S16).

Subsequently, the presentation information generation unit 40 generates the presentation information for presenting information indicating the congestion level (e.g., video information or audio information) by using the congestion level (step S17).

The processing in the steps S13 to S17 is repeated until a command for ending the measurement of the congestion level is received (step S18).

With the device, system, method and program according to the first embodiment, the number of only the mobile wireless terminals Mov #1-Mov #Y possessed by the guests Gst #1-Gst #Z can be measured without being influenced by the permanent wireless terminals Dev #1-Dev #X. Since the congestion level can be calculated from the mobile wireless terminal count as above, the accuracy of the congestion level presented to the guests Gst #1-Gst #Z can be increased.

Further, in cases where the wireless signals transmitted by the wireless terminals are received by a plurality of wireless sensors Sen #1-Sen #I, it is possible to present distribution of the mobile wireless terminals Mov #1-Mov #Y in the venue 9, namely, the congestion level in each region obtained by dividing the venue 9.

### Second Embodiment

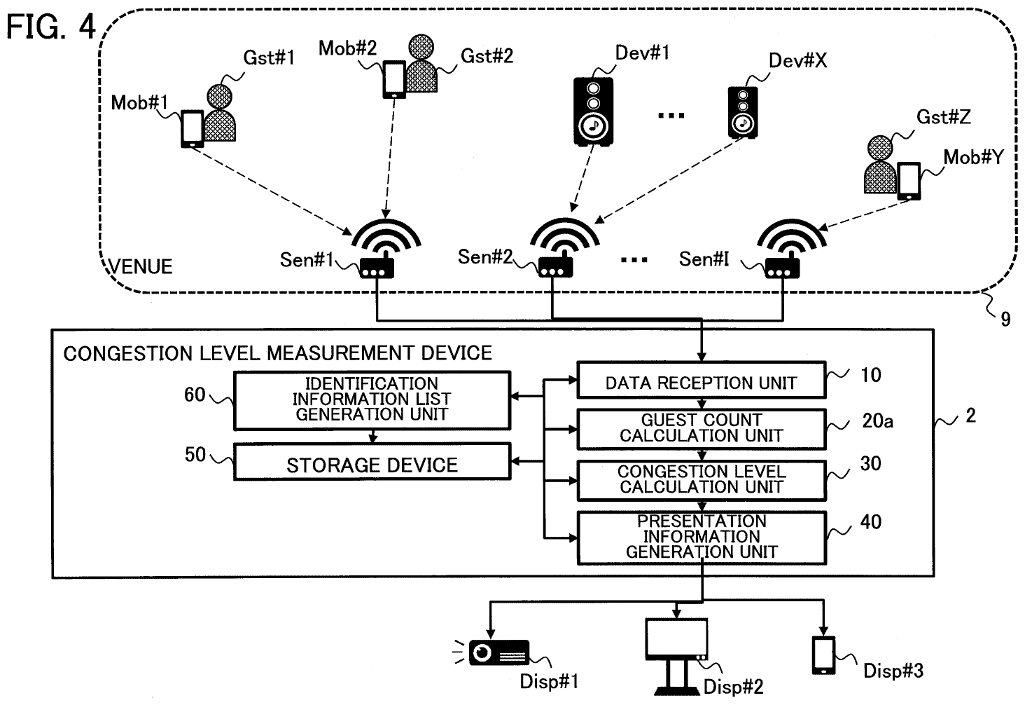

FIG. 4 is a diagram schematically showing the configuration of a congestion level measurement device 2 according to a second embodiment and a congestion level measurement system including the congestion level measurement device 2. The congestion level measurement system is formed with the congestion level measurement device 2 and one or more wireless sensors Sen #1-Sen #I. The congestion level measurement device 2 is a device for measuring the congestion level of guests in a previously set place. The congestion level measurement device 2 generates the presentation information for presenting the congestion level information regarding the measured congestion level. The congestion level measurement device 2 is a device capable of executing a congestion level measurement method according to the second embodiment. The congestion level measurement device 2 is a computer, for example. The congestion level measurement device 2 can also be a computer system formed by cloud computing by using a computer network.

In FIG. 4, each component identical or corresponding to a component shown in FIG. 1 is assigned the same reference character as in FIG. 1. The congestion level measurement device 2 according to the second embodiment differs from the congestion level measurement device 1 according to the first embodiment in including an identification information list generation unit 60 and in a process executed by a guest count calculation unit 20a. The congestion level measurement device 2 according to the second embodiment calculates the mobile wireless terminal count, as the number of mobile wireless terminals Mov #1-Mov #Y carried by the guests Gst #1-Gst #Z in the venue 9 and transmitting the wireless signals, based on the wireless data and permanent wireless terminal information (including identification information on the permanent wireless terminals Dev #1-Dev #X) acquired as information regarding the permanent wireless terminals Dev #1-Dev #X transmitting the wireless signals, and calculates the guest count as the number of guests Gst #1-Gst #Z from the mobile wireless terminal count.

The identification information list generation unit 60 of the congestion level measurement device 2 extracts the identification information for identifying the permanent wireless terminals Dev #1-Dev #X from the wireless data received in a period in which no guests are accommodated in the venue 9, and stores an identification information list made up of the identification information on the permanent wireless terminals Dev #1-Dev #X in the storage device 50.

The guest count calculation unit 20a calculates the mobile wireless terminal count based on the identification information list stored in the storage device 50 and the wireless data received in a period in which the guests Gst #1-Gst #Z are accommodated in the venue 9. Specifically, the guest count calculation unit 20a selects wireless data other than wireless data based on the wireless signals transmitted from the permanent wireless terminals Dev #1-Dev #X in the identification information list from the wireless data received in a period in which the guests Gst #1-Gst #Z are accommodated in the venue 9 (i.e., the wireless data based on the wireless signals transmitted from the permanent wireless terminals Dev #1-Dev #X and the wireless data based on the wireless signals transmitted from the mobile wireless terminals Mov #1-Mov #Y), and calculates the mobile wireless terminal count based on the selected wireless data (i.e., the wireless data based on the wireless signals transmitted from the mobile wireless terminals Mov #1-Mov #Y). The guest count calculation unit 20a calculates the guest count from the mobile wireless terminal count. In the calculation of the guest count, the assumed value A may be used.

In the second embodiment, the congestion level measurement system may include one or more information provision devices Disp #1-Disp #3 in addition to the congestion level measurement device 2 and the one or more wireless sensors Sen #1-Sen #I.

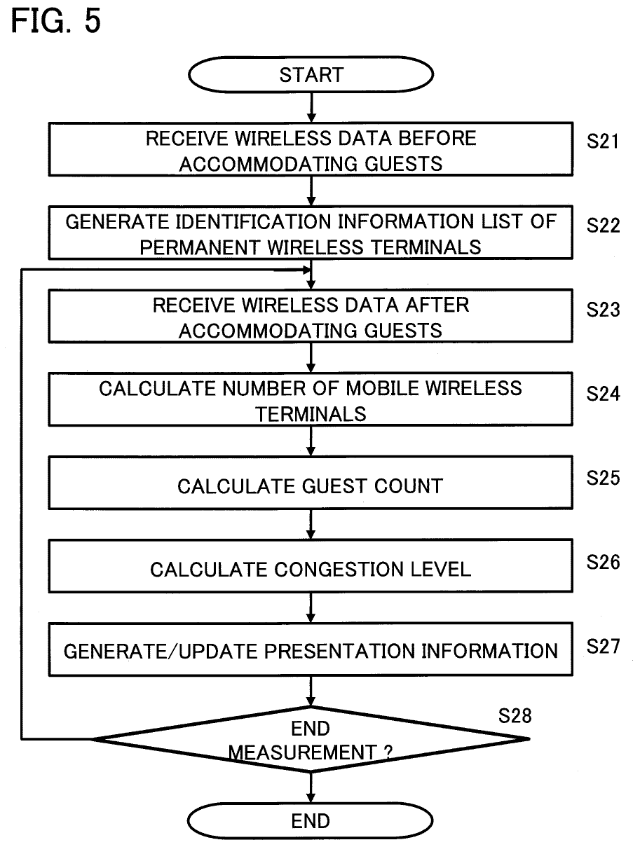

FIG. 5 is a flowchart showing the operation of the congestion level measurement device 2 according to the second embodiment. In the second embodiment, the identification information list generation unit 60 extracts the identification information on the permanent wireless terminals Dev #1-Dev #X from the wireless data received in a period in which no guests are accommodated in the venue 9, generates the identification information list of the permanent wireless terminals Dev #1-Dev #X, and stores the identification information list in the storage device 50 (steps S21 and S22).

Subsequently, the guest count calculation unit 20a selects wireless data other than wireless data based on the wireless signals transmitted from the permanent wireless terminals Dev #1-Dev #X in the identification information list stored in the storage device 50 from the wireless data received in a period in which the guests Gst #1-Gst #Z are accommodated in the venue 9, and calculates the mobile wireless terminal count based on the selected wireless data (i.e., the wireless data based on the wireless signals transmitted from the mobile wireless terminals Mov #1-Mov #Y) (steps S23 and S24). Subsequently, the guest count calculation unit 20a calculates the guest count from the mobile wireless terminal count (step S25). In the calculation of the guest count, a value other than 1 may be used as the assumed value A.

Subsequently, the congestion level calculation unit 30 calculates the congestion level in the venue 9 (or the congestion level of each region in the venue 9) (step S26).

Subsequently, the presentation information generation unit 40 generates the presentation information for presenting information indicating the congestion level (e.g., video information or audio information) by using the congestion level (step S27).

The processing in the steps S23 to S27 is repeated until the command for ending the measurement of the congestion level is received (step S28).

With the device, system, method and program according to the second embodiment, the number of only the mobile wireless terminals Mov #1-Mov #Y possessed by the guests Gst #1-Gst #Z can be measured without being influenced by the permanent wireless terminals Dev #1-Dev #X. Since the congestion level can be calculated from the mobile wireless terminal count, the accuracy of the congestion level presented to the guests Gst #1-Gst #Z can be increased.

Further, in cases where the wireless signals transmitted by the wireless terminals are received by a plurality of wireless sensors Sen #1-Sen #I, it is possible to present the distribution of the mobile wireless terminals Mov #1-Mov #Y in the venue 9, namely, the congestion level in each region obtained by dividing the venue 9.

Furthermore, in the second embodiment, the accuracy of the calculated guest count may be increased by executing the guest count calculation process (steps S11 to S15) in the first embodiment in addition to the guest count calculation process (steps S21 to S25). For example, it is possible to make a setting so as to execute the guest count calculation process (steps S21 to S25) again when the guest count calculated by the guest count calculation process (steps S21 to S25) in the second embodiment and the guest count calculated by the guest count calculation process (steps S11 to S15) in the first embodiment differ from each other. Alternatively, it is possible to employ a representative value (e.g., mean value) calculated from the guest count calculated by the guest count calculation process (steps S21 to S25) in the second embodiment and the guest count calculated by the guest count calculation process (steps S11 to S15) in the first embodiment as the guest count.

Except for the above-described features, the second embodiment is the same as the first embodiment.

### Third Embodiment

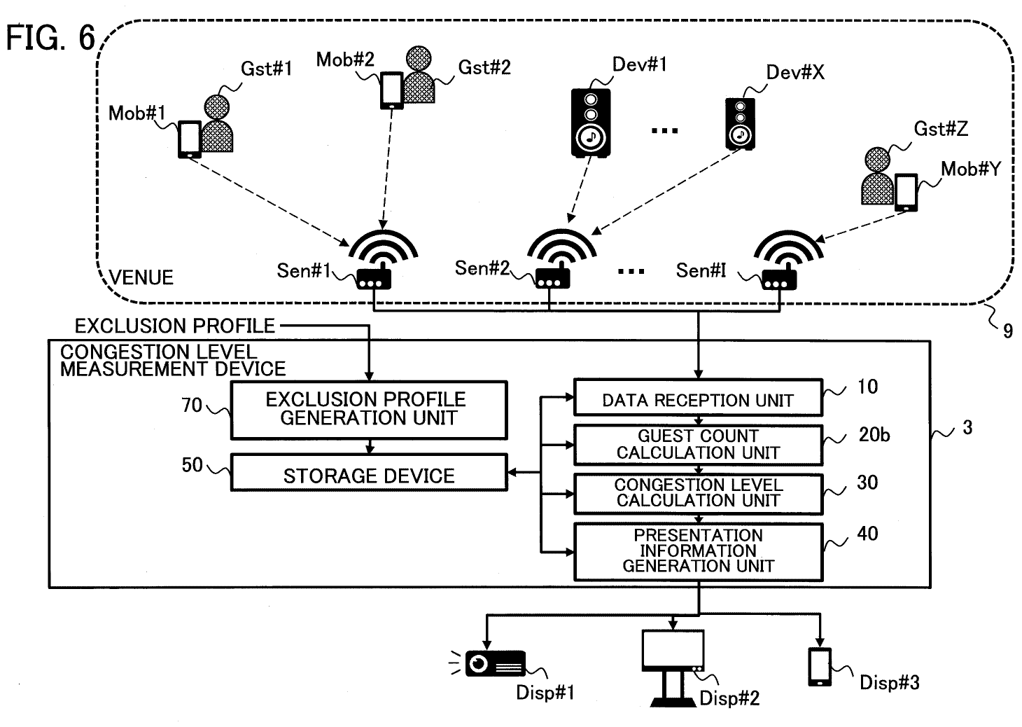

FIG. 6 is a diagram schematically showing the configuration of a congestion level measurement device 3 according to a third embodiment and a congestion level measurement system including the congestion level measurement device 3. The congestion level measurement system is formed with the congestion level measurement device 3 and one or more wireless sensors Sen #1-Sen #I. The congestion level measurement device 3 is a device for measuring the congestion level of guests in a previously set place. The congestion level measurement device 3 generates the presentation information for presenting the congestion level information regarding the measured congestion level. The congestion level measurement device 3 is a device capable of executing a congestion level measurement method according to the third embodiment. The congestion level measurement device 3 is a computer, for example. The congestion level measurement device 3 can also be a computer system formed by cloud computing by using a computer network.

In FIG. 6, each component identical or corresponding to a component shown in FIG. 1 is assigned the same reference character as in FIG. 1. The congestion level measurement device 3 according to the third embodiment differs from the congestion level measurement device 1 according to the first embodiment in further including an exclusion profile list generation unit 70 that previously acquires communication profiles of the wireless signals transmitted from the permanent wireless terminals Dev #1-Dev #X and stores an exclusion profile list as a profile list made up of the communication profiles in the storage device 50 and in a process executed by a guest count calculation unit 20b. The congestion level measurement device 3 according to the third embodiment calculates the mobile wireless terminal count, as the number of mobile wireless terminals Mov #1-Mov #Y carried by the guests Gst #1-Gst #Z in the venue 9 and transmitting the wireless signals, based on the wireless data and the permanent wireless terminal information acquired as information regarding the permanent wireless terminals Dev #1-Dev #X transmitting the wireless signals, and calculates the guest count from the mobile wireless terminal count.

The guest count calculation unit 20b receives the communication profiles of the wireless signals transmitted from the permanent wireless terminals Dev #1-Dev #X from the outside. While the communication profiles are inputted by the organizer (e.g., administrator) of the venue 9, the communication profiles may also be extracted from reception data received before the venue 9 is opened similarly to the second embodiment.

The guest count calculation unit 20b calculates the mobile wireless terminal count based on the exclusion profile list stored in the storage device 50 and the wireless data received in a period in which the guests Gst #1-Gst #Z are accommodated in the venue 9. Specifically, the guest count calculation unit 20b selects wireless data by excluding the permanent wireless terminals Dev #1-Dev #X using the communication profiles in the exclusion profile list from the wireless data received in a period in which the guests Gst #1-Gst #Z are accommodated in the venue 9 (i.e., the wireless data based on the wireless signals transmitted from the permanent wireless terminals Dev #1-Dev #X and the wireless data based on the wireless signals transmitted from the mobile wireless terminals Mov #1-Mov #Y), and calculates the mobile wireless terminal count based on the selected wireless data (i.e., the wireless data based on the wireless signals transmitted from the mobile wireless terminals Mov #1-Mov #Y).

In the third embodiment, the congestion level measurement system may include one or more information provision devices Disp #1-Disp #3 in addition to the congestion level measurement device 3 and the one or more wireless sensors Sen #1-Sen #I.

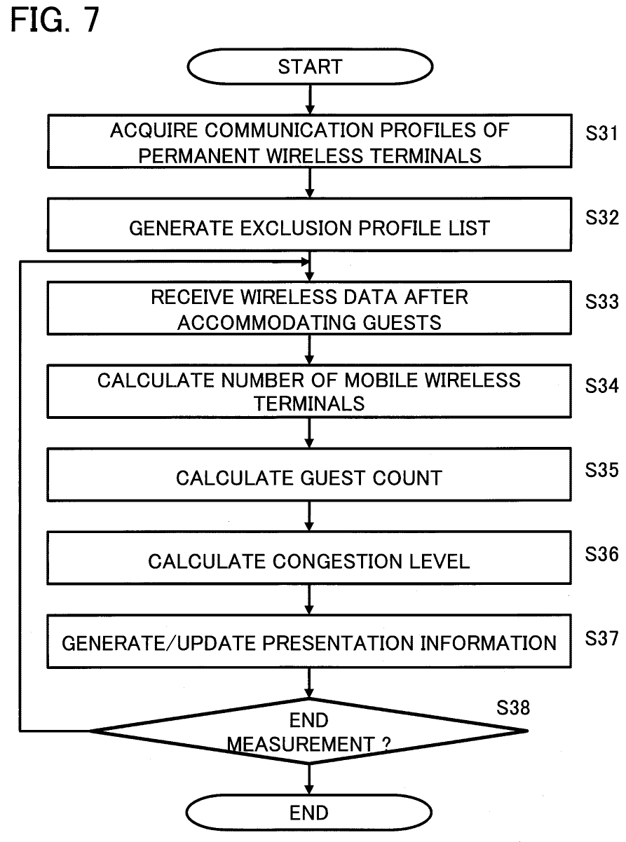

FIG. 7 is a flowchart showing the operation of the congestion level measurement device 3 according to the third embodiment. In the third embodiment, the exclusion profile list generation unit 70 previously acquires the communication profiles of the wireless signals transmitted from the permanent wireless terminals Dev #1-Dev #X and stores the exclusion profile list as a profile list made up of the communication profiles in the storage device 50 (steps S31 and S32). The communication profiles of the wireless signals transmitted from the permanent wireless terminals Dev #1-Dev #X may be either previously stored in the storage device 50 or recorded in the storage device 50 by a user operation.

Subsequently, the guest count calculation unit 20b selects wireless data other than wireless data based on the wireless signals using the communication profiles in the exclusion profile list stored in the storage device 50 from the wireless data received in a period in which the guests Gst #1-Gst #Z are accommodated in the venue 9, and calculates the mobile wireless terminal count based on the selected wireless data (i.e., the wireless data based on the wireless signals transmitted from the mobile wireless terminals Mov #1-Mov #Y) (steps S33 and S34). Subsequently, the guest count calculation unit 20b calculates the guest count from the mobile wireless terminal count (step S35). In the calculation of the guest count, a value other than 1 may be used as the assumed value A.

Subsequently, the congestion level calculation unit 30 calculates the congestion level in the venue 9 (or the congestion level of each region in the venue 9) (step S36).

Subsequently, the presentation information generation unit 40 generates the presentation information for presenting information indicating the congestion level (e.g., video information or audio information) by using the congestion level (step S37).

The processing in the steps S33 to S37 is repeated until the command for ending the measurement of the congestion level is received (step S38).

With the device, system, method and program according to the third embodiment, the number of only the mobile wireless terminals Mov #1-Mov #Y possessed by the guests Gst #1-Gst #Z can be measured without being influenced by the permanent wireless terminals Dev #1-Dev #X. Since the congestion level can be calculated from the mobile wireless terminal count, the accuracy of the congestion level presented to the guests Gst #1-Gst #Z can be increased.

Further, in cases where the wireless signals transmitted by the wireless terminals are received by a plurality of wireless sensors Sen #1-Sen #I, it is possible to present the distribution of the mobile wireless terminals Mov #1-Mov #Y in the venue 9, namely, the congestion level in each region obtained by dividing the venue 9.

Furthermore, in the third embodiment, the accuracy of the calculated guest count may be increased by executing at least one of the guest count calculation process (steps S11 to S15) in the first embodiment and the guest count calculation process (steps S21 to S25) in the second embodiment in addition to the guest count calculation process (steps S31 to S35).

For example, it is possible to make a setting so as to execute the guest count calculation process (steps S31 to S35) again when the guest count calculated by the guest count calculation process (steps S31 to S35) in the third embodiment and the guest count calculated by the guest count calculation process (steps S11 to S15) in the first embodiment differ from each other. Alternatively, it is possible to employ a representative value (e.g., mean value) calculated from the guest count calculated by the guest count calculation process (steps S31 to S35) in the third embodiment and the guest count calculated by the guest count calculation process (steps S11 to S15) in the first embodiment as the guest count.

Further, it is possible to make a setting so as to execute the guest count calculation process (steps S31 to S35) again when the guest count calculated by the guest count calculation process (steps S31 to S35) in the third embodiment and the guest count calculated by the guest count calculation process (steps S21 to S25) in the second embodiment differ from each other. Alternatively, it is possible to employ a representative value (e.g., mean value) calculated from the guest count calculated by the guest count calculation process (steps S31 to S35) in the third embodiment and the guest count calculated by the guest count calculation process (steps S21 to S25) in the second embodiment as the guest count.

Alternatively, it is possible to employ a representative value (e.g., mean value) calculated from the guest count calculated by the guest count calculation process (steps S31 to S35) in the third embodiment, the guest count calculated by the guest count calculation process (steps S11 to S15) in the first embodiment, and the guest count calculated by the guest count calculation process (steps S21 to S25) in the second embodiment as the guest count.

Except for the above-described features, the third embodiment is the same as the first or second embodiment.

### Fourth Embodiment

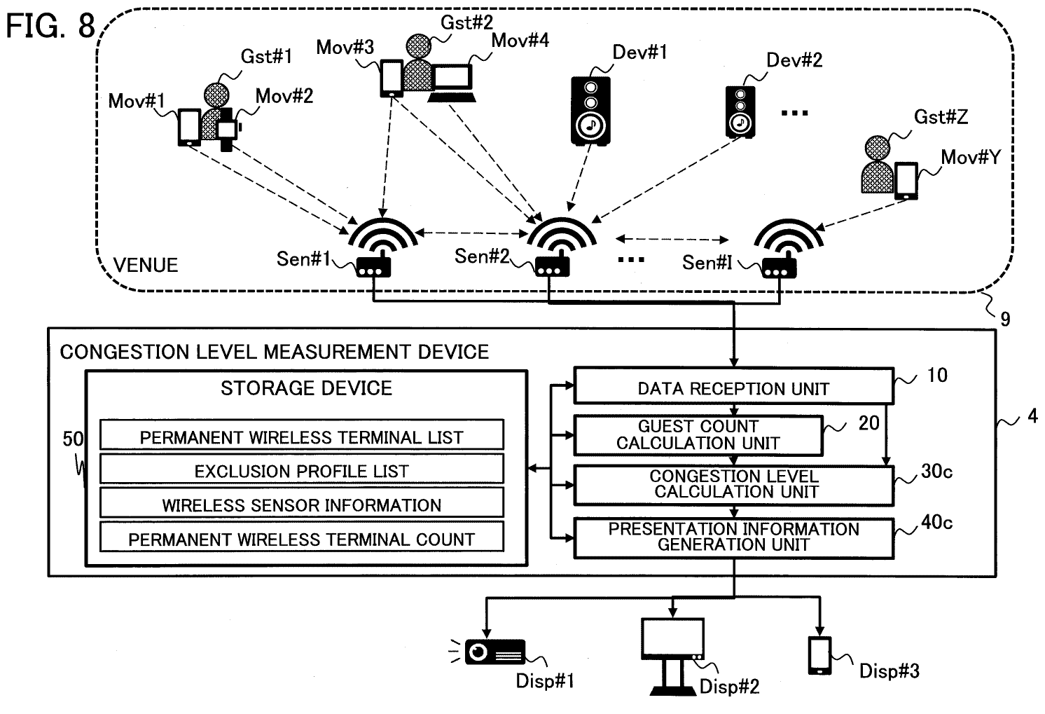

FIG. 8 is a diagram schematically showing the configuration of a congestion level measurement device 4 according to a fourth embodiment and a congestion level measurement system including the congestion level measurement device 4. The congestion level measurement system is formed with the congestion level measurement device 4 and a plurality of wireless sensors Sen #1-Sen #I. The congestion level measurement device 4 is a device for measuring the congestion level of guests in a previously set place. Further, the congestion level measurement device 4 generates the presentation information for presenting the congestion level information regarding the measured congestion level. The congestion level measurement device 4 is a device capable of executing a congestion level measurement method according to the fourth embodiment. The congestion level measurement device 4 is a computer, for example. The congestion level measurement device 4 can also be a computer system formed by cloud computing by using a computer network.

In FIG. 8, each component identical or corresponding to a component shown in FIG. 1 is assigned the same reference character as in FIG. 1. The congestion level measurement device 4 according to the fourth embodiment differs from the congestion level measurement device 1 according to the first embodiment in a process executed by a congestion level calculation unit 30c and in a process executed by a presentation information generation unit 40c. In the fourth embodiment, the congestion level measurement system may include one or more information provision devices Disp #1-Disp #3 in addition to the congestion level measurement device 4 and the plurality of wireless sensors Sen #1-Sen #I.

In the fourth embodiment, each of the plurality of wireless sensors Sen #1-Sen #I periodically transmits the advertisement signal as a wireless signal. A considered wireless sensor among the plurality of wireless sensors Sen #1-Sen #I receives the advertisement signals respectively transmitted from wireless sensors adjacent to the considered wireless sensor and measures reception signal intensity of the received advertisement signals. The congestion level measurement device 4 receives the reception signal intensity of the received advertisement signals from each of the plurality of wireless sensors Sen #1-Sen #I, and by using the reception signal intensity of the received advertisement signals, executes processes such as dynamic update of receivable regions, detection of an overlapping wireless terminal as a wireless terminal transmitting a wireless signal received by a plurality of wireless sensors, and calculation of a congestion level gradient vector indicating a change in the congestion level in the venue 9. The receivable region is a region in which a signal at supposed reference signal intensity can be received at reception signal intensity higher than or equal to lower limit reception signal intensity, and the receivable region varies due to variations in radio attenuation in the vicinity. For example, since the high water content in human bodies has a radio wave absorption effect, the attenuation rate of the reception signal intensity with the increase in the distance becomes higher in a congested environment. Accordingly, the actual receivable region of the wireless sensor becomes smaller than a design value and there is a tendency of measuring a lower congestion level.

The processes executed by the congestion level calculation unit 30c and the presentation information generation unit 40c of the congestion level measurement device 4 according to the fourth embodiment are applicable to any one of the first, second and third embodiments.

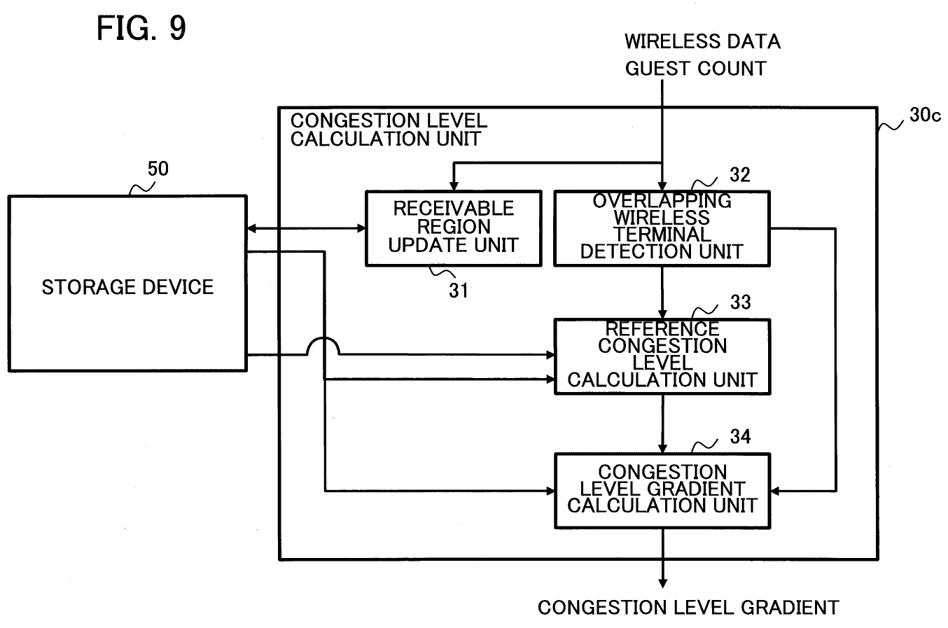

FIG. 9 is a functional block diagram showing the configuration of the congestion level calculation unit 30c. The congestion level calculation unit 30c includes a receivable region update unit 31, an overlapping wireless terminal detection unit 32, a reference congestion level calculation unit 33, a congestion level gradient calculation unit 34 and the storage device 50.

The storage device 50 stores wireless sensor information regarding each of the plurality of wireless sensors Sen #1-Sen #I. The wireless sensor information includes installation position information indicating the installation position of each of the plurality of wireless sensors Sen #1-Sen #I and receivable region information indicating the receivable region of each of the plurality of wireless sensors Sen #1-Sen #I. The receivable region information stored in the storage device 50 is updated by the receivable region update unit 31 periodically or with arbitrary timing. Further, the storage device 50 may also store one or more out of the permanent wireless terminal count described in the first embodiment, the identification information list described in the second embodiment, and the exclusion profile list described in the third embodiment.

The receivable region update unit 31 calculates the receivable region of each of the plurality of wireless sensors Sen #1-Sen #I based on variation in the reception signal intensity regarding each wireless signal (e.g., advertisement signal as a predetermined wireless signal) transmitted and received by wireless sensors adjacent to each other, and updates the receivable region information on each of the plurality of wireless sensors Sen #1-Sen #I held in the storage device 50. Here, the receivable region means a region in which a wireless signal at the supposed reference signal intensity T_{dev} [dBm] of a wireless terminal can be received at reception signal intensity higher than or equal to the lower limit reception signal intensity RSSIₘᵢₙ [dBm]. For the calculation of the receivable region, the following expression (1) as a publicly known expression regarding the reception signal intensity RSSI [dBm] can be used:

$$RSSI = T - 10 n log ( d ) \qquad ( 1 )$$

In the expression (1), d represents the distance between a wireless transmitter (the adjacent wireless sensor in this example) and a wireless receiver (the considered wireless sensor in this example). T [dBm] represents the reference signal intensity as the reception signal intensity when a reference wireless signal transmitted from the wireless transmitter is measured at a position that is a unit distance separate from the wireless transmitter. Further, n represents a coefficient indicating the degree of occurrence of the radio attenuation in the environment. It has been known that n=2.0 in a free space with no obstacle in the vicinity and n>2.0 in a congested space where the radio attenuation is likely to occur.

A calculation formula for obtaining a maximum reception distance dₘₐₓ at which a wireless signal at the supposed reference signal intensity T_{dev} of a wireless terminal arrives at the lower limit reception signal intensity RSSIₘᵢₙ can be obtained by deleting n from the above expression (1) and organizing the expression (1) in regard to d. The calculation formula for obtaining the maximum reception distance dₘₐₓ is shown below as expression (2).

$${d}_{max} = 10 \hat{} ( \frac{{T}_{d e v} - {RSSI}_{min}}{{T}_{s e n} - {RSSI}_{s e n}} log ( {d}_{s e n} ) ) \qquad ( 2 )$$

In the expression (2), dₛₑₙ represents the distance to the adjacent wireless sensor, RSSIₛₑₙ [dBm] represents the reception signal intensity of the wireless signal transmitted from the adjacent wireless sensor, and Tₛₑₙ [dBm] represents the reference signal intensity as the intensity of the wireless signal transmitted from the adjacent wireless sensor. Further, in the expression (2), the supposed reference signal intensity T_{dev}, the reference signal intensity Tₛₑₙ, the lower limit reception signal intensity RSSIₘᵢₙ and the distance dₛₑₙ are known values. Therefore, by using the expression (2), the maximum reception distance dₘₐₓ at the time of day can be calculated from the value of the reception signal intensity RSSIₛₑₙ.

Namely, the data reception unit 10 receives the wireless data based on the predetermined wireless signals (e.g., the advertisement signals) periodically transmitted from the adjacent wireless sensors as other wireless sensors and received by the considered wireless sensor 80 among the plurality of wireless sensors, and the congestion level calculation unit 30c is capable of dynamically updating the receivable region 90 of each considered wireless sensor 80 based on the reception signal intensity of the predetermined wireless signals regarding each considered wireless sensor 80.

While the expression (2) indicates an example of the method of calculating the maximum reception distance dₘₐₓ, it is also possible to use a different calculation method as long as the method is designed to be able to calculate the maximum reception distance dₘₐₓ based on the reception signal intensity RSSIₛₑₙ.

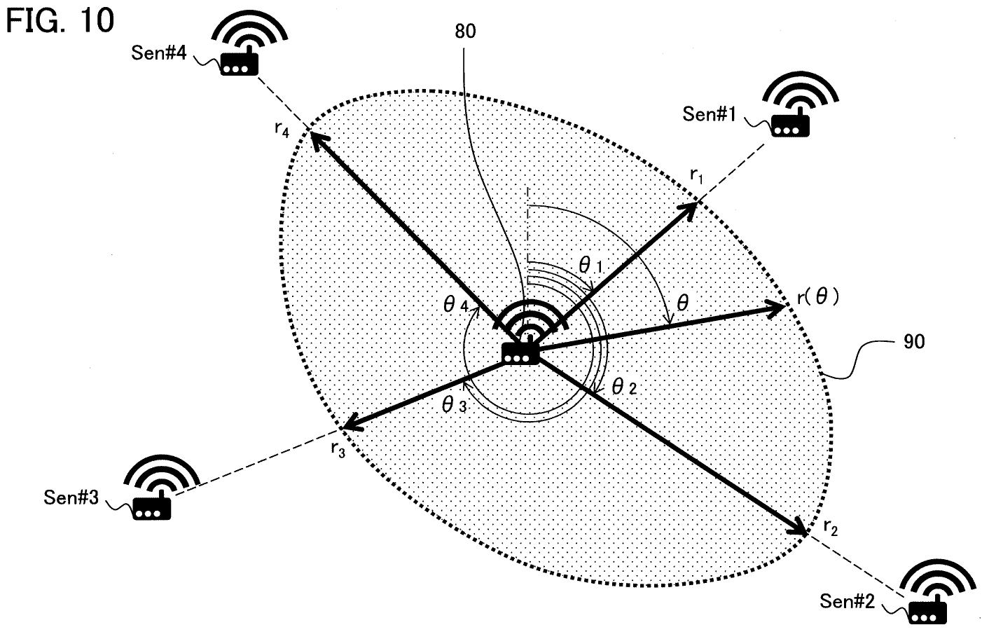

FIG. 10 is a diagram showing the receivable region 90 of the considered wireless sensor 80 among the plurality of wireless sensors Sen #1-Sen #I. Since the maximum reception distance dₘₐₓ of the considered wireless sensor 80 is a physical quantity that can be calculated for each adjacent wireless sensor, when there exist N adjacent wireless sensors (N: positive integer), N maximum reception distances dₘₐₓ are obtained in regard to N directions respectively pointing towards the N adjacent wireless sensors. FIG. 10 shows an example in which N=4. There is a method using the following expressions (3.1), (3.2) and (3.3) as an example of a method for determining an appropriate receivable region 90 based on these N maximum reception distances dₘₐₓ:

$$r ( θ ) = \frac{1}{W} {\sum }_{i = 1}^{N} {w}_{i} {r}_{i} , \qquad ( 3.1 )$$

$$W = {\sum }_{i = 1}^{N} {w}_{i} , \qquad ( 3.2 )$$

$${w}_{i} = \frac{1}{1 - cos ( θ - {θ}_{i} ) + δ} . \qquad ( 3.3 )$$

In the expressions (3.1), (3.2) and (3.3), the receivable region 90 is represented by a variable radius r(θ) around the considered wireless sensor 80. The expressions (3.1), (3.2) and (3.3) have been designed so that the variable radius r(θ) takes on a value close to the maximum reception distance d. #1 calculated between the considered wireless sensor 80 and the wireless sensor Sen #i (i: integer greater than or equal to 1 and less than or equal to N) when the direction θᵢ in which the wireless sensor Sen #i adjacent to the considered wireless sensor 80 exists and the direction θ as a variable are close to each other. This feature is due to the expression (3.3) that causes a greater weight wᵢ as the direction θ becomes closer to the direction θᵢ. Incidentally, 6 in the expression (3.3) is a minute constant and has a function of preventing division by zero. Parenthetically, when the maximum reception distance cannot be calculated due to failure in the communication with the adjacent wireless sensor or the like, it is also possible to manually set a range that seems to be appropriate based on specifications of the wireless sensor.

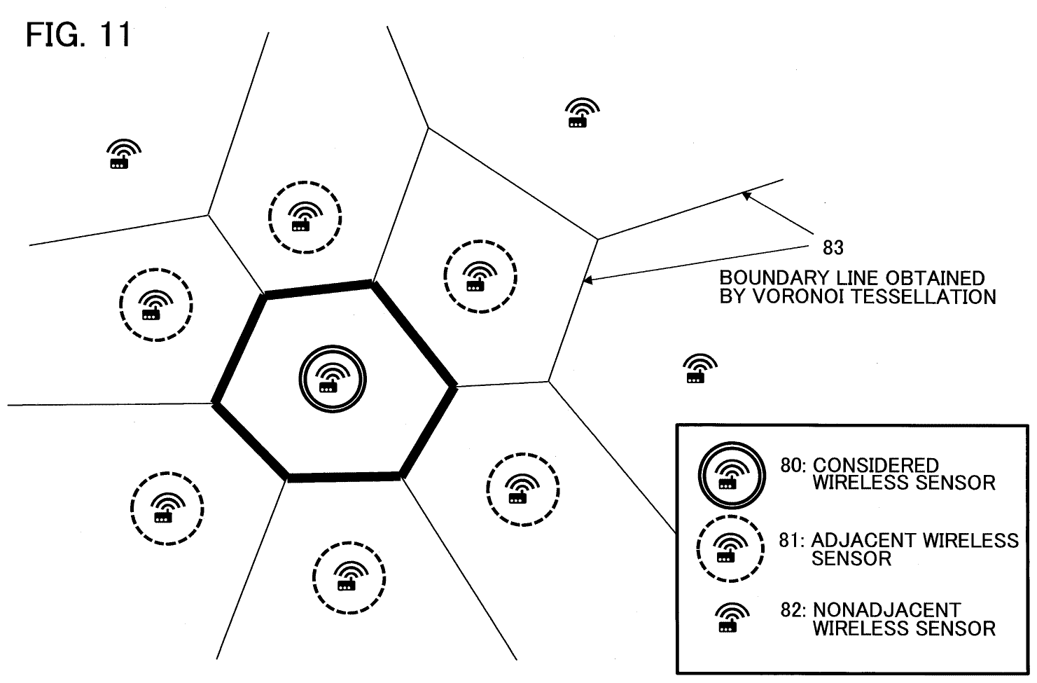

FIG. 11 is a diagram showing a partitioning region obtained by partitioning by the considered wireless sensor 80, the adjacent wireless sensors 81 and nonadjacent wireless sensors 82. The partitioning region is a region determined by a geometrical calculation procedure such as Voronoi tessellation. While a method for judging whether two wireless sensors are adjacent to each other or not is not particularly limited, a method by the Voronoi tessellation can be used as an example. In this method, as shown in FIG. 11, the Voronoi tessellation is performed while defining the position of each wireless sensor as the center of an element, the partitioning region is specified in regard to each of a plurality of wireless sensors Sen #1-Sen #N (N: positive integer indicating the number of adjacent wireless sensors 81), and wireless sensors sharing a boundary line of partitioning regions are handled as adjacent wireless sensors 81.

While the expression (2) and the expressions (3.1), (3.2) and (3.3) are mathematical expressions for calculating the receivable region of each wireless sensor, the calculation by using these mathematical expressions cannot be performed when a sufficient calculation resource cannot be secured or the distance dₛₑₙ is unknown. As a preparation for such cases, it is possible to prepare a method for calculating the density (i.e., the congestion level) of mobile wireless terminals in a simple manner. Specifically, the mobile wireless terminal count calculated by the congestion level calculation unit may be corrected based on the variation in the reception signal intensity measured by each wireless sensor. In off-times, the actual mobile wireless terminal count as the number of mobile wireless terminals existing in the vicinity of a wireless sensor and the detected mobile wireless terminal count as the number of mobile wireless terminals captured by the wireless sensor roughly coincide with each other. However, in peak times, it has been known that the number of mobile wireless terminals captured by the wireless sensor becomes smaller than the number of actually existing mobile wireless terminals, and consequently, the mean value of the reception signal intensity becomes higher than that in off-times. This results from impossibility of receiving low-intensity signals due to radio interference in the venue.

By taking advantage of this phenomenon, when the reception signal intensity is higher than that in off-times, the accuracy of the congestion level can be increased by making a correction so as to increase the mobile wireless terminal count depending on how higher the reception signal intensity is than that in off-times.

For example, when there are a plurality of wireless sensors in the venue 9, the data reception unit 10 of the congestion level measurement device 4 receives the wireless data, based on the predetermined signals periodically transmitted from other wireless sensors among the plurality of wireless sensors, from each of the plurality of wireless sensors, and the congestion level calculation unit 30c corrects the number of mobile wireless terminals captured by the wireless sensor (i.e., the density or the congestion level of mobile wireless terminals) based on the reception signal intensity of the predetermined wireless signals received by the plurality of wireless sensors. For example, when the reception signal intensity of the predetermined wireless signals received by the plurality of wireless sensors is high, the congestion level calculation unit 30c makes the correction so as to increase the number of mobile wireless terminals captured by the wireless sensor (i.e., the density or the congestion level of mobile wireless terminals) depending on how high the reception signal intensity is.

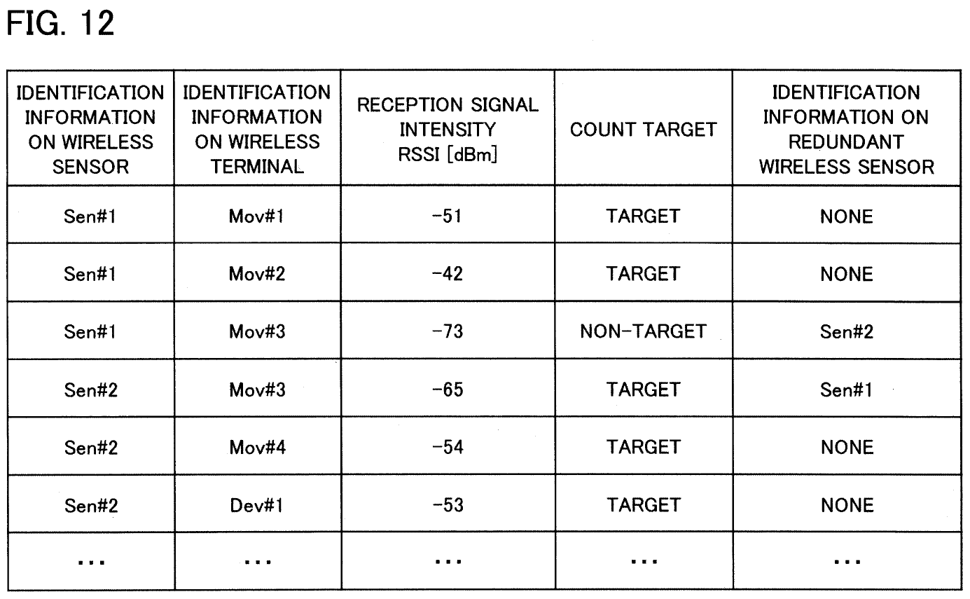

FIG. 12 is a diagram showing an example of the output from the overlapping wireless terminal detection unit 32 in tabular form. In regard to a list of wireless terminals from which each wireless sensor received wireless signals, the overlapping wireless terminal detection unit 32 performs recording of information on wireless sensors redundantly received a wireless signal and judgments on whether or not each wireless terminal should be handled as a count target in regard to the wireless sensor. In the example in FIG. 12, while the wireless signal transmitted from the mobile wireless terminal Mov #3 as a wireless terminal is received by both of the wireless sensor Sen #1 and the wireless sensor Sen #2, the reception signal intensity RSSI at the wireless sensor Sen #2 (−65 dBm in FIG. 12) is higher than the reception signal intensity RSSI at the wireless sensor Sen #1 (−73 dBm in FIG. 12), and thus only the wireless sensor Sen #2 handles the mobile wireless terminal Mov #3 as a wireless terminal as a count target (target of counting).

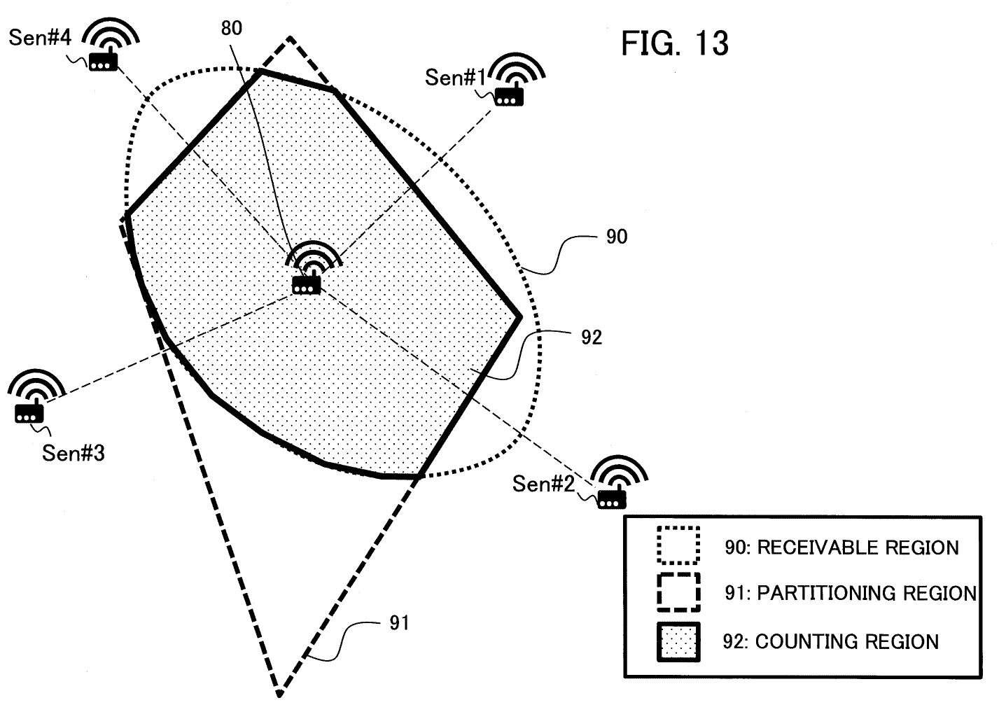

FIG. 13 is a diagram showing a counting region 92 in a reference congestion level calculation process. The reference congestion level calculation unit 33 calculates a reference congestion level by dividing the total number of wireless terminals handled as count targets by the area of the counting region 92 and the number of possessed mobile wireless terminals per guest. Here, the counting region 92 is a region as an overlap between the receivable region 90 and the partitioning region 91. Since the number of possessed wireless terminals per guest is generally unknown, an assumed value a (e.g., predetermined value) is employed. The partitioning region is a region determined by a geometrical calculation procedure such as the Voronoi tessellation.

When the considered wireless sensor 80 and the adjacent wireless sensor 81 redundantly received the wireless signals transmitted from wireless terminals, the congestion level gradient calculation unit 34 calculates a bias of the congestion level (i.e., congestion level gradient) based on a ratio regarding numbers of wireless terminals, and generates a congestion level map that has taken the bias of the congestion level into consideration. First, the bias of the congestion level between the considered wireless sensor 80 and one adjacent wireless sensor is calculated by using the following expression (4):

$${BIAS}_{i} = \{ \frac{( count ( {CL}_{i} ⋂ CL ) + {λ}_{CL} ) / ( c ount ( CL ) + {λ}_{CL} )}{( a rea ( R {R}_{i} ⋂ RR ) + {λ}_{RR} ) / ( area ( RR ) + {λ}_{RR} )} - 1 \} {p}_{i} . \qquad ( 4 )$$

In the expression (4), the vector pᵢ represents a directional vector heading from the considered wireless sensor 80 towards the adjacent wireless sensor 81 (i.e., wireless sensor Sen #i). RR represents the receivable region 90 of the considered wireless sensor 80, and RRᵢ represents the receivable region of the adjacent wireless sensor Sen #i. CL represents a set of mobile wireless terminals from which the considered wireless sensor 80 received the wireless signal, and CLᵢ represents a set of mobile wireless terminals from which the adjacent wireless sensor Sen #i received the wireless signal.

Further, “RRᵢ ∩RR” represents an overlap region as the overlap between the receivable region RRᵢ and the receivable region RR. “CLᵢ ∩CL” represents a set of mobile wireless terminals as the overlap between the set CLᵢ and the set CL. The function area(R) is a function that returns the area of the region R, and the function count(L) is a function that returns the number of elements included in the set L. The term λ_{CL} is a positive constant term for stabilizing the calculation result when the count(CL) is small, and the term λ_{RR} is a positive constant term for stabilizing the calculation result when the area(RR) is small.

The congestion level gradient vector BIAS₁ shown on the left side of the expression (4) represents a vector regarding the direction of the wireless sensor Sen #i, and has a length corresponding to the bias of the distribution of the mobile wireless terminals.

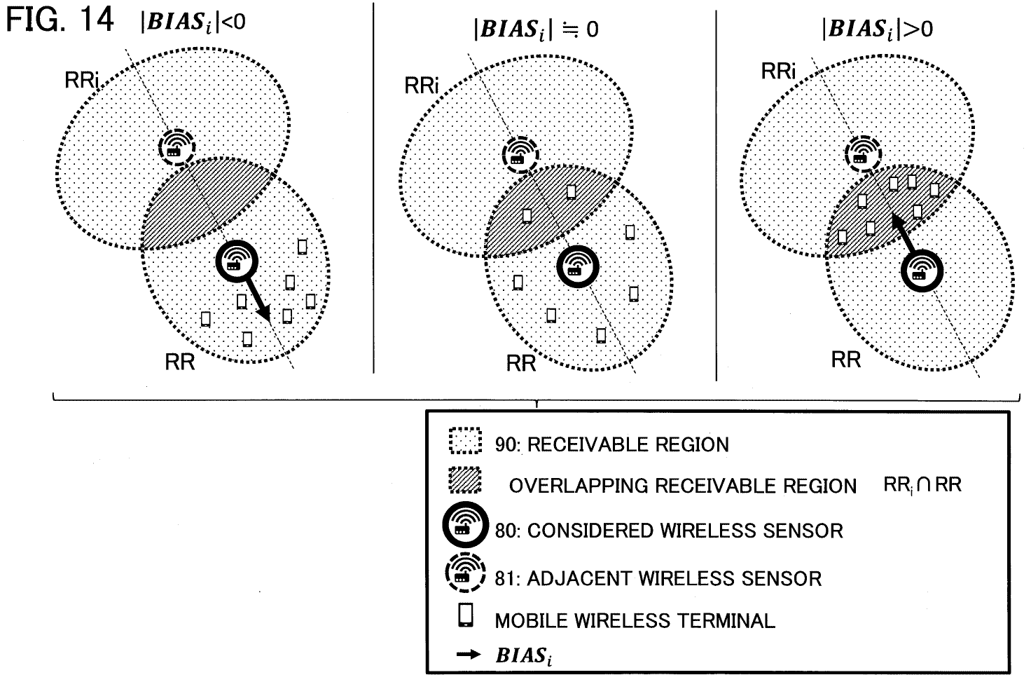

As shown in FIG. 14, the length of the congestion level gradient vector BIAS₁ is less than 0 (i.e., |BIAS₁|<0) when the number of mobile wireless terminals in the overlap region “RRᵢ ∩RR” is small, and is greater than 0 (i.e., |BIAS₁|>0) when the number of wireless terminals in the overlap region “RRᵢ ∩RR” is large. As many congestion level gradient vectors BIAS₁ as the number of adjacent wireless sensors can be calculated for the considered wireless sensor 80.

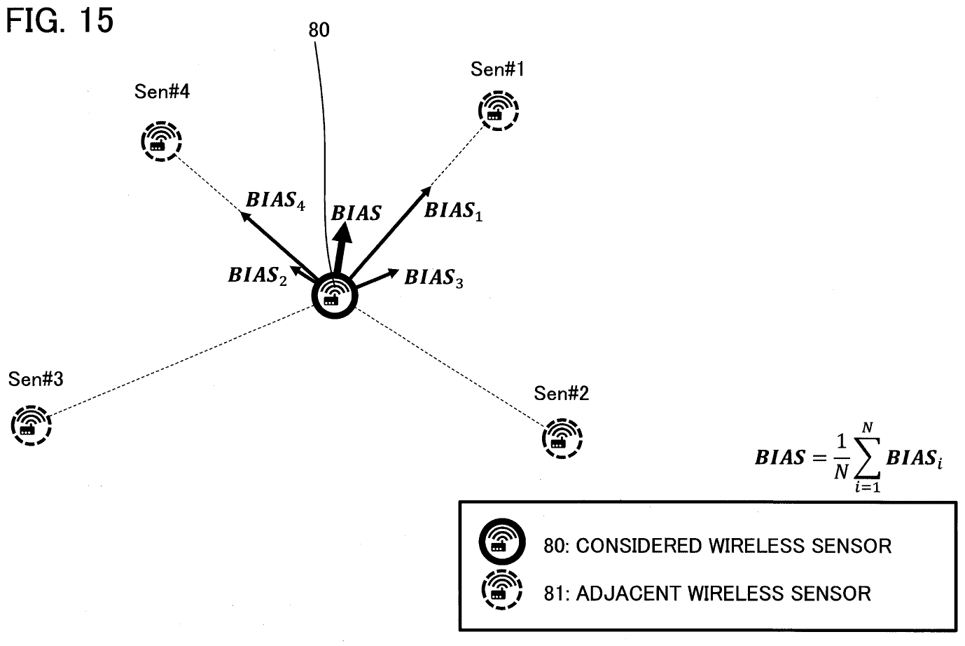

FIG. 15 is a diagram showing an example of a process for calculating the congestion level gradient vector BIAS₁. As shown in FIG. 15 and expression (5), a final congestion level gradient vector BIAS is determined by calculating a mean vector. In FIG. 15, N=4.

$$BIAS = \frac{1}{N} {\sum }_{i = 1}^{N} {BIAS}_{i} . \qquad ( 5 )$$

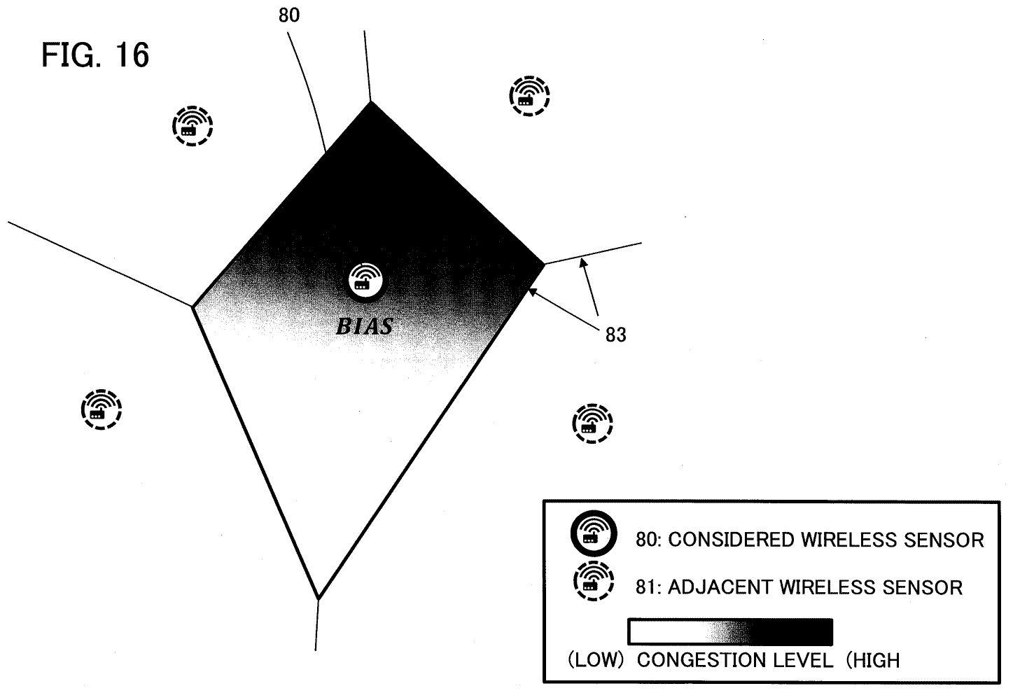

FIG. 16 is a diagram showing a display example of the congestion level. The final congestion level gradient vector BIAS indicates the direction of the change in the congestion level at the considered wireless sensor 80. After the calculation of the congestion level gradient vectors BIAS₁ regarding the adjacent wireless sensors Sen #1-Sen #N, a method of displaying the partitioning region (e.g., color, density of the color, brightness, movement of a display region, and so forth) is determined based on the reference congestion level and the final congestion level gradient vector BIAS as shown in FIG. 16. For example, it is possible to employ a display method in which boundary lines 83 of detection regions respectively assigned to the considered wireless sensor 80 and the adjacent wireless sensors are displayed as lines and the density changes stepwise or continuously in the direction of the final congestion level gradient vector BIAS (the density increases with the increase in the congestion level) in a display image presented to the guests. It is also possible to employ a display method in which the brightness increases with the increase in the congestion level, a display method in which the color changes more with the increase in the congestion level (e.g., blue color gradually turns into red color with the increase in the congestion level), or the like.

Put another way, the congestion level calculation unit 30c calculates the congestion level gradient vector BIAS₁, as the gradient of the congestion level in the direction of a line connecting the considered wireless sensor 80 among the plurality of wireless sensors and an adjacent wireless sensor 81 adjacent to the considered wireless sensor 80, regarding each of the adjacent wireless sensors 81 and calculates the final congestion level gradient vector BIAS based on the congestion level gradient vector BIAS₁ regarding each of the adjacent wireless sensors 81, and the presentation information generation unit 40c is capable of generating the presentation information so that display condition changes gradually or stepwise in the direction of the final congestion level gradient vector BIAS.

The display condition changing gradually or stepwise can include, for example, one or more out of display color changing gradually or stepwise, density changing gradually or stepwise, brightness changing gradually or stepwise, a pattern changing gradually or stepwise, and movement of video changing gradually or stepwise. The display condition changing gradually or stepwise can also be, for example, a combination of two or more out of the display color changing gradually or stepwise, the density changing gradually or stepwise, the brightness changing gradually or stepwise, the pattern changing gradually or stepwise, and the movement of video changing gradually or stepwise.

Further, as the display condition changing gradually or stepwise, the presentation information generation unit 40c can select one or more out of the display color, the density, the brightness, the pattern, and the movement of video of the partitioning region assigned to each of the plurality of wireless sensors.

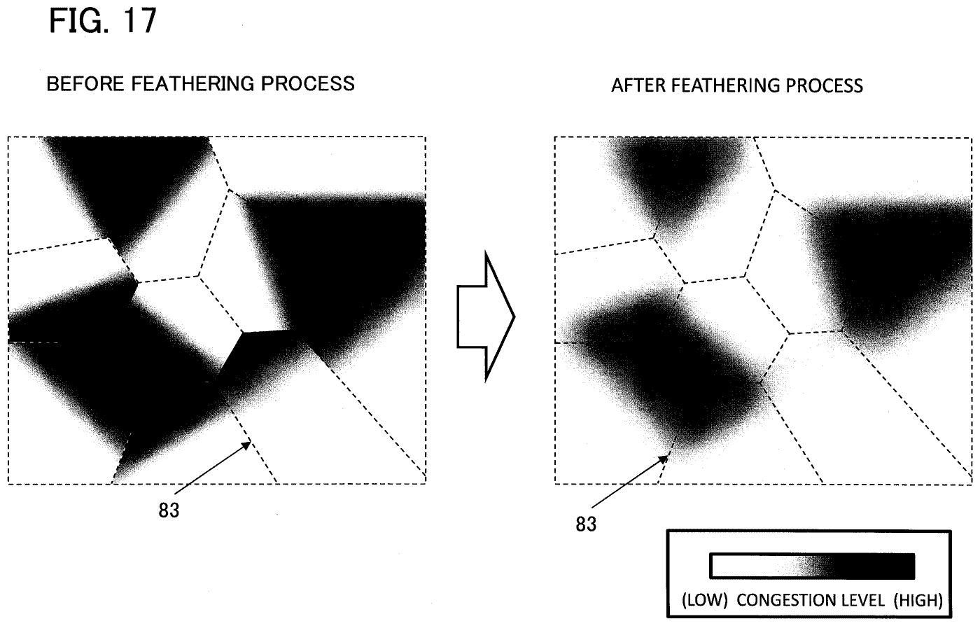

FIG. 17 is a diagram showing display examples of the congestion level before a feathering process and after the feathering process. After determining the display color in regard to each one of the partitioning regions of the wireless sensors Sen #1-Sen #N, if discontinuity of the display color in the vicinity of boundary lines of partitioning regions is conspicuous, the feathering process such as a Gaussian filter may be applied as shown in FIG. 17.

With the device, system, method and program according to the fourth embodiment, a wireless sensor in charge of each of the plurality of regions in the venue 9 can be determined appropriately in consideration of the attenuation rate of the reception signal intensity dynamically changing due to the radio wave absorption effect of the human bodies of the guests. Accordingly, the measurement accuracy of the congestion level can be increased.

Further, with the device, system, method and program according to the fourth embodiment, when displaying the congestion level map, the display method (e.g., the color, the density of the color, the brightness, the pattern, the movement of video, and so forth) can be changed gradually based on the congestion level gradient vector BIAS calculated for each wireless sensor in charge of its respective region, and thus the congestion level information can be provided to the guests in an appropriate manner.

### DESCRIPTION OF REFERENCE CHARACTERS

1-4: congestion level measurement device, 9: venue (place), 10: data reception unit, 20, 20a, 20b: guest count calculation unit, 30, 30c: congestion level calculation unit, 40, 40c: presentation information generation unit, 50: storage device, 60: identification information list generation unit, 70: exclusion profile list generation unit, Gst #1-Gst #Z: guest, Sen #1-Sen #I: wireless sensor, Dev #1-Dev #X: permanent wireless terminal, Mob #1-Mob #Y: mobile wireless terminal, Disp #1-Disp #3: information provision device.

What is claimed is:

1. A congestion level measurement device comprising:
processing circuitry
to receive wireless data based on wireless signals received by one or more wireless sensors in a place having been set in order to accommodate guests;
to calculate a mobile wireless terminal count, as a number of mobile wireless terminals carried by the guests in the place and transmitting the wireless signals, based on the wireless data or based on the wireless data and permanent wireless terminal information acquired as information regarding permanent wireless terminals transmitting the wireless signals, and to calculate a guest count as the number of the guests from the mobile wireless terminal count;
to calculate a congestion level, indicating a degree of congestion with the guests in the place, based on the guest count;
to obtain a permanent wireless terminal count as the number of the permanent wireless terminals based on the wireless data received in a period in which no guests are accommodated in the place;
to obtain a wireless terminal count, as a sum total of the permanent wireless terminal count and the mobile wireless terminal count, based on the wireless data received in a period in which the guests are accommodated in the place; and
to calculate the mobile wireless terminal count by subtracting the permanent wireless terminal count from the wireless terminal count.

2. A congestion level measurement device comprising:
processing circuitry
to receive wireless data based on wireless signals received by one or more wireless sensors in a place having been set in order to accommodate guests;
to calculate a mobile wireless terminal count, as a number of mobile wireless terminals carried by the guests in the place and transmitting the wireless signals, based on the wireless data or based on the wireless data and permanent wireless terminal information acquired as information regarding permanent wireless terminals transmitting the wireless signals, and to calculate a guest count as the number of the guests from the mobile wireless terminal count;
to extract identification information for identifying the permanent wireless terminals from the wireless data received in a period in which no guests are accommodated in the place and stores an identification information list made up of the identification information in a storage device; and
to calculate the mobile wireless terminal count based on the identification information list and the wireless data received in a period in which the guests are accommodated in the place.

3. A congestion level measurement device comprising:
processing circuitry
to receive wireless data based on wireless signals received by one or more wireless sensors in a place having been set in order to accommodate guests;
to calculate a mobile wireless terminal count, as a number of mobile wireless terminals carried by the guests in the place and transmitting the wireless signals, based on the wireless data or based on the wireless data and permanent wireless terminal information acquired as information regarding permanent wireless terminals transmitting the wireless signals, and to calculate a guest count as the number of the guests from the mobile wireless terminal count;
to previously acquire communication profiles of the wireless signals transmitted from the permanent wireless terminals and stores an exclusion profile list made up of the communication profiles in a storage device; and
to calculate the mobile wireless terminal count based on the exclusion profile list and the wireless data received in a period in which the guests are accommodated in the place.

4. The congestion level measurement device according to claim 1, wherein
the one or more wireless sensors include a plurality of wireless sensors,
the processing circuitry
receives wireless data based on predetermined wireless signals periodically transmitted from other wireless sensors and received by a considered wireless sensor among the plurality of wireless sensors, and
dynamically updates a receivable region of each considered wireless sensor based on reception signal intensity of the predetermined wireless signals regarding each considered wireless sensor.

5. The congestion level measurement device according to claim 1, wherein
the one or more wireless sensors include a plurality of wireless sensors,
the processing circuitry receives wireless data based on predetermined wireless signals periodically transmitted from other wireless sensors among the plurality of wireless sensors and received by each of the plurality of wireless sensors, and
the processing circuitry corrects the congestion level based on reception signal intensity of the predetermined wireless signals received by the plurality of wireless sensors.

6. The congestion level measurement device according to claim 5, wherein when the reception signal intensity of the predetermined wireless signals received by the plurality of wireless sensors is high, the processing circuitry makes a correction so as to increase the congestion level.

7. The congestion level measurement device according to claim 1, wherein
the one or more wireless sensors include a plurality of wireless sensors,
the processing circuitry
calculates a congestion level gradient vector, as a gradient of the congestion level in a direction of a line connecting a considered wireless sensor among the plurality of wireless sensors and an adjacent wireless sensor adjacent to the considered wireless sensor, regarding each adjacent wireless sensor,
calculates a final congestion level gradient vector based on the congestion level gradient vector regarding each adjacent wireless sensor, and
generates presentation information so that display condition changes gradually or stepwise in the direction of the final congestion level gradient vector.

8. The congestion level measurement device according to claim 4, wherein the processing circuitry
calculates a congestion level gradient vector, as a gradient of the congestion level in a direction of a line connecting a considered wireless sensor among the plurality of wireless sensors and an adjacent wireless sensor adjacent to the considered wireless sensor, regarding each adjacent wireless sensor,
calculates a final congestion level gradient vector based on the congestion level gradient vector regarding each adjacent wireless sensor, and
generates presentation information so that display condition changes gradually or stepwise in the direction of the final congestion level gradient vector.

9. The congestion level measurement device according to claim 6, wherein the processing circuitry
calculates a congestion level gradient vector, as a gradient of the congestion level in a direction of a line connecting a considered wireless sensor among the plurality of wireless sensors and an adjacent wireless sensor adjacent to the considered wireless sensor, regarding each adjacent wireless sensor,
calculates a final congestion level gradient vector based on the congestion level gradient vector regarding each adjacent wireless sensor, and
generates presentation information so that display condition changes gradually or stepwise in the direction of the final congestion level gradient vector.

10. The congestion level measurement device according to claim 7, wherein the display condition includes one or more out of display color, density, brightness, a pattern, and movement of video.

11. The congestion level measurement device according to claim 7, wherein the display condition includes one or more out of display color, density, brightness, a pattern, and movement of video of a partitioning region assigned to each of the plurality of wireless sensors.

12. A congestion level measurement system comprising:
the congestion level measurement device according to claim 1; and
one or more wireless sensors.

13. A congestion level measurement method comprising:
receiving wireless data based on wireless signals received by one or more wireless sensors in a place having been set in order to accommodate guests;
calculating a mobile wireless terminal count, as a number of mobile wireless terminals carried by the guests in the place and transmitting the wireless signals, based on the wireless data or based on the wireless data and permanent wireless terminal information acquired as information regarding permanent wireless terminals transmitting the wireless signals, and calculating a guest count as the number of the guests from the mobile wireless terminal count;
calculating a congestion level, indicating a degree of congestion with the guests in the place, based on the guest count;
calculating a congestion level, indicating a degree of congestion with the guests in the place, based on the guest count;
obtaining a permanent wireless terminal count as the number of the permanent wireless terminals based on the wireless data received in a period in which no guests are accommodated in the place;
obtaining a wireless terminal count, as a sum total of the permanent wireless terminal count and the mobile wireless terminal count, based on the wireless data received in a period in which the guests are accommodated in the place; and
calculating the mobile wireless terminal count by subtracting the permanent wireless terminal count from the wireless terminal count.

14. A non-transitory computer-readable storage medium for storing a congestion level measurement program that causes a computer to execute processing comprising:
receiving wireless data based on wireless signals received by one or more wireless sensors in a place having been set in order to accommodate guests;
calculating a mobile wireless terminal count, as a number of mobile wireless terminals carried by the guests in the place and transmitting the wireless signals, based on the wireless data or based on the wireless data and permanent wireless terminal information acquired as information regarding permanent wireless terminals transmitting the wireless signals, and calculating a guest count as the number of the guests from the mobile wireless terminal count;
calculating a congestion level, indicating a degree of congestion with the guests in the place, based on the guest count;
calculating a congestion level, indicating a degree of congestion with the guests in the place, based on the guest count;
obtaining a permanent wireless terminal count as the number of the permanent wireless terminals based on the wireless data received in a period in which no guests are accommodated in the place;
obtaining a wireless terminal count, as a sum total of the permanent wireless terminal count and the mobile wireless terminal count, based on the wireless data received in a period in which the guests are accommodated in the place; and
calculating the mobile wireless terminal count by subtracting the permanent wireless terminal count from the wireless terminal count.
